(19) United States
(12) Patent Application Publication
(10) Pub. No.: US 2020/0372877 A1
(43) Pub. Date: Nov. 26, 2020

(54) AUTOMATIC BRIGHTNESS CONTROL OF ELECTRONIC DISPLAYS

(71) Applicant: Visteon Global Technologies, Inc., Van Buren Township, MI (US)

(72) Inventor: Paul Fredrick Luther Weindorf, Novi, MI (US)

(73) Assignee: Visteon Global Technologies, Inc., Van Buren Township, MI (US)

(21) Appl. No.: 16/418,312

(22) Filed: May 21, 2019

(51) Int. Cl. G09G 5/10; H04N 5/58; G06F 3/14

(52) U.S. Cl. CPC G09G 5/10; H04N 5/58; B60K 2370/349; G09G 2320/0626; G06F 3/1423

(57) ABSTRACT

A system includes first and second light sensors, first and second electronic displays and a control circuit. The first light sensor may face a first direction and generates a first light intensity signal by logarithmic light sensing. The first electronic display may face the first direction and has a first brightness responsive to a first brightness signal. The second light sensor may face a second direction and generates a second light intensity signal by logarithmic light sensing. The second direction may be substantially opposite the first direction. The second electronic display may face the second direction and has a second brightness responsive to a second brightness signal. The control circuit may be configured to generate the first and second brightness signals that automatically adjust the first and second brightness of the first and second electronic displays using the first light intensity signal and the second light intensity signal.

### TECHNICAL FIELD

The present disclosure generally relates to automatic brightness control of electronic displays, and in particular to electronic displays visible from an exterior of a vehicle under different lighting conditions in different viewing directions.

### BACKGROUND

Many pioneers have studied and performed numerous human factor studies to understand what display luminance a human visual system utilizes for display visibility. Dr. Louis Silverstein and Robin Hoerner published a paper “The Development and Evaluation of Color Systems for Airborne Applications—Phase I: Fundamental Visual Perceptual, and Display Systems Considerations” that outlined an automatic luminance control system. Dr. Silverstein and Hoerner found that in addition to increasing a display luminance as a function of reflected display background luminance, as measured by an internal light sensor, display visibility performance could be improved by the utilization of a forward-looking light sensor to compensate for conditions of transient adaptation or eye adaptation mismatch. In the paper, a gain factor (GF) of the forward-looking eye adaptation mismatch compensation was described by formula 1 as follows:

GF=(1.125×log(FFVI/WSI))+0.2982 (1)

The value FFVI is a forward field of view intensity and WSI is a display white stroke intensity. However, an actual implementation of the automatic luminance control function proposed by Dr. Silverstein and Hoerner included linear light sensing that did not have a dynamic range of 6-8 decades suitable for automotive applications. Furthermore, a processor throughput consumed in calculating the luminance control mathematical functions was excessive for the automotive applications.

### SUMMARY

This section provides a general summary of the disclosure and is not a comprehensive disclosure of its full scope or all of its features, aspects or objectives.

A system for automatic brightness control of a plurality of displays is provided herein. The system may include a first light sensor, a second light sensor, a first electronic display, a second electronic display and a control circuit. The first light sensor generally faces a first direction and may be configured to generate a first light intensity signal by logarithmic sensing a first light signal. The first electronic display of the plurality of displays generally faces the first direction and may have a first brightness responsive to a first brightness signal.

The second light sensor generally faces a second direction and may be configured to generate a second light intensity signal by logarithmic sensing a second light signal. The second direction may be substantially opposite the first direction. The second electronic display of the plurality of displays generally faces the second direction and may have a second brightness responsive to a second brightness signal.

The control circuit may be configured to generate the first brightness signal that automatically adjusts the first brightness of the first electronic display using the first light intensity signal in a first ambient light control loop and the second light intensity signal in a first remote light control loop. The control circuit may also be configured to generate the second brightness signal that automatically adjusts the second brightness of the second electronic display using the second light intensity signal in a second ambient light control loop and the first light intensity signal in a second remote light control loop.

Another system for automatic brightness control of a plurality of displays is provided herein. The system may include a plurality of first light sensors, a plurality of first electronic displays, a plurality of second light sensors, a plurality of second electronic displays and a control circuit. The plurality of first light sensors generally face in substantially opposite directions along a first axis and may be configured to generate a plurality of first light intensity signals by logarithmic sensing a plurality of first light signals. The plurality of first electronic displays generally face in substantially opposite directions along the first axis, and may have a plurality of first brightnesses responsive to a plurality of first brightness signals.

The plurality of second light sensor generally face in substantially opposite directions along a second axis and may be configured to generate a plurality of second light intensity signals by logarithmic sensing of a plurality of second light signals. The second axis may be non-parallel to the first axis. The plurality of second electronic displays generally face in substantially opposite directions along the second axis and may have a plurality of second brightnesses responsive to a plurality of second brightness signals.

The control circuit may be configured to generate the first brightness signals that automatically adjust each of the first brightnesses of the first electronic displays in response to at least two of the first light intensity signals. The control circuit may also be configured to generate the second brightness signals that automatically adjust each of the second brightnesses of the second electronic displays in response to at least two of the second light intensity signals.

A vehicle with automatic brightness control of a plurality of displays is provided herein. The vehicle may include a first light sensor, a first electronic display, a second light sensor, a second electronic display and a control circuit. The first light sensor may be attached to the vehicle, may face a first direction away from the vehicle, and may be configured to generate a first light intensity signal by logarithmic sensing a first light signal. The first display of the plurality of displays may be attached to the vehicle, may face the first direction, and may have a first brightness responsive to a first brightness signal.

The second light sensor may be attached to the vehicle, may face a second direction away from the vehicle, and may be configured to generate a second light intensity signal by logarithmic sensing a second light signal. The second direction may be substantially opposite the first direction. The second electronic display of the plurality of displays, may be attached to the vehicle, may face the second direction, and may have a second brightness responsive to a second brightness signal. The control circuit may be configured to generate the first brightness signal that automatically adjusts the first brightness of the first electronic display using the first light intensity signal in a first ambient light control loop and the second light intensity signal in a first remote light control loop.

The control circuit may also be configured to generate the second brightness signal that automatically adjusts the second brightness of the second electronic display using the second light intensity signal in a second ambient light control loop and the first light intensity signal in a second remote light control loop.

Further objects, features and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1 illustrates a context of a system.

FIG. 2 illustrates a schematic diagram of a multi-display control circuit in accordance with one or more embodiments of the system.

FIG. 3 illustrates a schematic diagram of a brightness circuit in accordance with one or more embodiments of the system.

FIG. 4 illustrates a functional flow diagram of an ambient light control loop and a remote light control loop in accordance with one or more embodiments of the system.

FIG. 5 illustrates a graph of a relationship between a gain factor value and a resulting index difference value in accordance with one or more embodiments of the system.

FIG. 6 illustrates a schematic diagram of a multi-light sensor electronic display in accordance with one or more embodiments of the system.

### DETAILED DESCRIPTION

The present disclosure may have various modifications and alternative forms, and some representative embodiments are shown by way of example in the drawings and will be described in detail herein. Novel aspects of this disclosure are not limited to the particular forms illustrated in the above-enumerated drawings. Rather, the disclosure is to cover modifications, equivalents, and combinations falling within the scope of the disclosure as encompassed by the appended claims.

Embodiments generally utilize light sensors on exterior facing electronic displays mounted on (or in) a body of a vehicle (or structure) to properly set brightness (or luminance) levels so that the electronic displays may be visible under a variety of lighting conditions. For each set of light sensors and electronic displays, one or more light sensors associated with a corresponding electronic display is used in conjunction with one or more light sensor on another corresponding electronic display mounted on an opposing side of the vehicle to set the brightness levels. The brightness of each electronic display may be automatically adjusted based on an intensity of the light sensed on both sides of the vehicle. Various embodiments may utilize logarithmic light sensing to provide a dynamic range of at least several (e.g., 8) decades. Some embodiments may implement multiple lookup table structures to simplify the automatic brightness control functions.

As the electronic displays are utilized more often in automotive and/or other outdoor applications (e.g., kiosks, traffic signs, etc.), an ability to see the display presentations under various lighting conditions becomes important. The use of the electronic displays in exterior applications is beginning to emerge for applications such as: exterior entry, exterior information such as battery charge level, advertising, vehicle service branding, vehicle identification, and/or rider instructions. The electronic displays may be used to communicate with, convey information and/or interact with people or other objects outside of the vehicle and other objects incorporating the electronic displays.

In various embodiments, one or more electronic displays may be used in a ride-share scenario to show availability of a vehicle to various people. The ride-share availability may be indicated on an hourly, daily, weekly and/or monthly basis. By way of example, the electronic displays may present a schedule such as 9:00 AM—available; 10:00 AM—booked; 11:00 AM—booked; 12:00 PM—available, etc. The schedule may also indicate locations and times. For example, the schedule may be Monday through Friday 8:30 AM—location A to location B 5:00 PM—location B to location A; Saturday only 7:00 AM—location A to location C, etc. Fees associate with the ride sharing may be included.

In some embodiments, the electronic display(s) may be used in purchasing scenarios to show information about the vehicle. The information may include standard features and added features commonly found on window stickers for new and used cars. The price of the vehicle may be included in the information. For used vehicles, the information may include a maintenance summary, such as when new tires were last installed.

In some embodiments, one or more electronic displays may include one or more quick response (QR) codes. A ride-share QR code shown by the electronic display(s) may be scanned by potential riders for booking purposes. A for-sale QR code may be scanned by potential buyers for purchasing purposes. An advertising QR code may direct people scanning the code to advertisement about the vehicle or other products. Some QR codes may include a history of the vehicle in advance of booking or purchasing. For example, a potential rider may have user settings in their cell phone that certain vehicles are preferred vehicles and/or other vehicles are to be avoided in the future. Emergency QR codes may direct police, paramedics and other first responders to secure websites that contain information about an owner of the vehicle.

To maintain display visibility under exterior ambient lighting conditions, electronic display luminance levels on the order of several thousand (e.g., 3,000) candela per square meter (cd/m²) may be anticipated. However, such luminance levels may not be useful under all daytime lighting scenarios. In order to reduce display luminances and appending power dissipation, the use of automatic luminance control is a desirable feature. In addition to reduce average battery power consumption for electric vehicle applications, the electronic display life may also be extended with the use of automatic luminance control.

Consider a person (or user) viewing an electronic display while looking toward a bright light source, such as the sun. An ambient light sensor on the electronic display being viewed may be in a shadow. Therefore, the brightness of the electronic display would normally be at a reduced level. The light sensor on the opposing electronic display may be used to measure a forward-looking (e.g., same direction as the viewer) light value and to adjust the electronic display being viewed accordingly. With the light adaptation, the viewer may see the electronic display at a more appropriate higher brightness level.

The use of the remote forward-looking light sensor that measures the luminance that the user is seeing, may be utilized in conjunction with the one or more ambient light sensors near the electronic display to maintain display visibility under all lighting conditions while minimizing average operational electronic display brightness values. Since each electronic display, located on each of the four sides of the vehicle, generally includes one or more light sensors, each light sensor may function as the ambient light sensor for the corresponding electronic display and as the forward-looking light sensor for the electronic display on the opposing side of the vehicle. Therefore, each light sensor on each of the display sides may have a dual purpose of serving as both the ambient light sensor in an ambient light control loop for the adjacent electronic display, and as a remote light sensor in a remote light control loop for the electronic display on the opposite side of the vehicle.

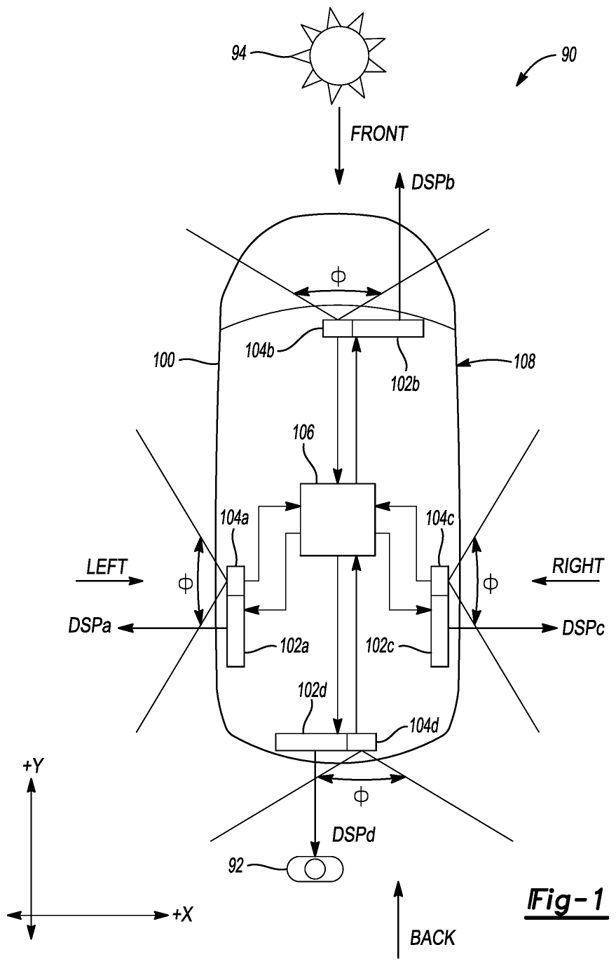

FIG. 1 illustrates a context of a system 90. The system 90 generally comprises a user (or person) 92, a light source 94 and a vehicle 100. The vehicle 100 generally comprises multiple electronic displays 102a-102d, multiple light sensors 104a-104d and a control circuit 106. Each electronic display 102a-102d may generate a visible image signals DSPa-DSPd at a variable intensity. Incident light signals (e.g., LEFT, FRONT RIGHT and BACK) may be received by the light sensors 104a-104d, respectively. A Cartesian X-Y coordinate may be aligned with the vehicle 100 with a front of the vehicle 100 oriented in a positive Y direction and a right side of the vehicle 100 oriented in a positive X direction.

As illustrated, the user 92 may be looking along the positive Y direction and so viewing a rear end of the vehicle 100. The user 92 may see the image DSPd generated by the electronic display 102d and the incident light signal BACK reflecting from the electronic display 102d and a back side of the vehicle 100. The vehicle 100 may be positioned between the user 92 and the light source 94 (e.g., the sun). As such, the user 92 may also be viewing the incident light signal FRONT generated by the light source 94. A body 108 of the vehicle 100 may block the incident light signal FRONT from the light sensor 104d.

Each electronic display 102a-102d may implement a visual light display. The electronic displays 102a-102d are generally operational to generate the visible image signals DSPa-DSPd based on information received from a control circuit 106. The electronic displays 102a-102d may be mounted on (or in) the body 108 of the vehicle 100. A brightness of the visible image signals DSPa-DSPd may be varied based on respective light select values received from the control circuit 106. In various embodiments, the electronic displays 102a-102d may be implemented as, but are not limited to, light emitting diode displays, organic light emitting diode displays and/or thin-film-transistor (TFT) liquid crystal displays (LCDs). In various embodiments, each electronic display 102a-102d may have a brightness of up to 3,000 cd/m². Other numbers of electronic displays 102a-102d, other orientations of the electronic displays 102a-102d and/or other brightness ranges may be implemented to meet the design criteria of a particular application.

Each light sensor 104a-104d may implement a visible light sensor. The light sensors 104a-104d are generally operational to generate corresponding light intensity signals by logarithmically sensing the incident light signals LEFT, FRONT, RIGHT and BACK. The light sensors 104a-104d may be mounted on (or in) the body 108 of the vehicle 100 approximately orthogonal to each other. In some embodiments, the light sensors 104a-104d may be integrated into the corresponding electronic displays 102a-102d. In other embodiments, the light sensors 104a-104d may be mounted to the body 108 separate from the electronic displays 102a-102d. Each light sensor 104a-104d may have a field of view (Φ) of approximately 180 degrees. Thus, the light sensors 104a-104d may sense the incident light received by the vehicle 100 from any direction. In the example illustrated, the light sensors 104a and 104c may be facing substantially opposite directions (e.g., 160 degrees to 200 degrees) along the X axis. The light sensors 104b and 104d may be facing substantially opposite directions (e.g., 160 degrees to 200 degrees) along the Y axis. Other numbers of light sensors 104a-104d, other fields of view and/or other orientations of the light sensors 104a-104d may be implemented to meet the design criteria of a particular application.

The control circuit 106 may implement an electronic control unit. The control circuit 106 is generally operational to generate message information for the electronic displays 102a-102d to present information external to the vehicle 100. The control circuit 106 may also be operational to automatically adjust the brightness of the electronic displays 102a-102d based on the light intensity signals received from the light sensors 104a-104d. The control circuit 106 may implement an ambient light control loop and a remote light control loop for each electronic display 102a-102d. Each ambient light control loop may adjust the brightness of the corresponding electronic display 102a-102d based on the incident light signal LEFT, FRONT, RIGHT or BACK received by the neighboring light sensor 104a-104d. Each remote light control loop may adjust the brightness of the corresponding electronic display 102a-102d based on the incident light signal LEFT, FRONT, RIGHT or BACK received by the light sensor 104a-104d facing the opposite direction.

In the example illustrated in FIG. 1, the light sensor 104d may act as the ambient light sensor and the light sensor 104b may act as the remote light sensor for the back electronic display 102d. At the same time, the light sensor 104d may act as the remote light sensor and the light sensor 104b may act as the ambient light sensor for the front electronic display 102b. The light sensor 104d may be responsive to the incident light signal BACK. The light sensor 104b may be responsive to the incident light signal FRONT. The control circuit 106 may be operational to use the electronic signals generated by the light sensors 104b and 104d to adjust the brightness of both electronic displays 102b and 102d.

The body 108 may implement a structure of the vehicle 100 and may include windows. The body 108 is generally configured to mount the electronic displays 102a-102d and the light sensors 104a-104d. In various embodiments, the electronic displays 102a-102d and the light sensors 104a-104d may be mounted at different heights above the ground on which the vehicle 100 sits. In some embodiments, the electronic displays 102a-102d and the light sensors 104a-104d may be mounted at a common height above the ground.

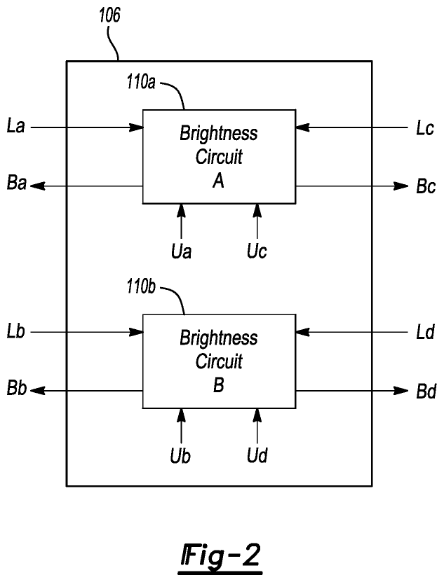

FIG. 2 illustrates a schematic diagram of an example implementation of a four-display control circuit 106 in accordance with one or more embodiments of the system 90. The control circuit 106 generally comprises multiple brightness circuits 110a-110b. The electronic signals (e.g., La-Ld) may be received from the light sensors 104a-104d, respectively. The display signals (e.g., Ba-Bd) may be generated by the control circuit 106 and presented to the electronic displays 102a-102d, respectively. Multiple display user bias signals (e.g., Ua-Ud) may be received by the control circuit 106 and received by the brightness circuits 110a-110b. The user bias signals Ua-Ud may be generated based on one or more inputs received from outside the control circuit 106 to adjust the luminance of the electronic displays 102a-102d. In some embodiments, the user bias signals Ua-Ud may be individually controlled. In other embodiments, the user bias signals Ua-Ud may be controlled together as if a single signal.

The electronic signals La-Ld may convey intensity values logarithmically related to an intensity of the incident light signals LEFT, FRONT, RIGHT and BACK, respectively. The brightness signals Ba-Bd may convey brightness values that control the brightnesses of the electronic displays 102a-102d. The display user bias signals Ua-Ud may carry user bias values that provide for a user (e.g., a driver) control of the brightnesses of the electronic displays 102a-102d.

Each brightness circuit 110a-110b may implement an automatic brightness control circuit. The brightness circuit 110a is generally operational to control the brightness of the electronic displays 102a and 102c based on the intensity values received in the electronic signals La and Lc from the light sensors 104a and 104c. The brightness circuit 110b is generally operational to control the brightness of the electronic displays 102b and 102d based on the intensity values received in the electronic signals Lb and Ld from the light sensors 104b and 104d.

By way of example, if an operator of the vehicle 100 wants the electronic displays 102a-102d to be brighter than a nominal table value, the operator may set a bias value (or an offset value) through a manually-activated control. The bias value may be transferred to the control circuit 106 to adjust the brightness of the electronic displays 102a-102d. The manually-activated control may be adjustable via a switch, a potentiometer, a touch screen and/or remotely via a mobile device. In another example where a battery power falls below a given threshold voltage, the control circuit 106 may sense the low batter voltage and subsequently adjusts the user bias values in the user bias signals Ua-Ud. The adjustment may reduce a nominal display luminance lower from a nominal value to conserve battery power. In another example, where one electronic display 102a-102d (e.g., 102c) is wearing out, the user bias value in the corresponding user bias signal Uc may be adjusted to increase the luminance of the display 102c above the nominal case. Other sources of the inputs suitable to adjust the user bias signals Ua-Ud may be implemented to meet the design criteria of a particular application.

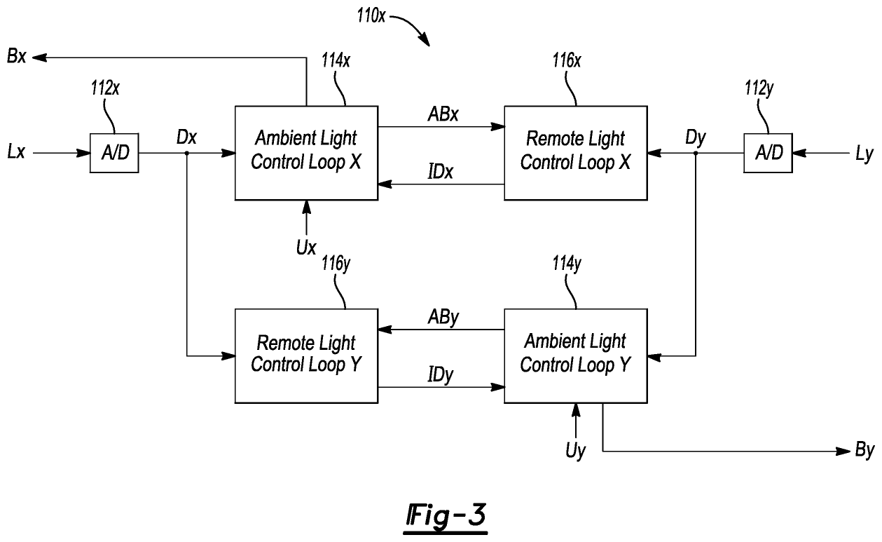

FIG. 3 illustrates a schematic diagram of an example implementation of a brightness circuit 110x in accordance with one or more embodiments of the system 90. The brightness circuit 110x may be representative of each brightness circuit 110a-110b shown in FIG. 2. The brightness circuit 110x generally comprises multiple analog-to-digital (A/D) converters 112x-112y, multiple ambient light control loop circuits 114x-114y and multiple remote light control loop circuits 116x-116y.

The analog-to-digital converter 112x may receive an electronic signal (e.g., Lx) as one of the electronic signals La-Ld from one of the light sensors 104a-104d. The analog-to-digital converter 112x may generate a digital intensity signal (e.g., Dx) received by the ambient light control loop 114x and the remote light control loop 116y. The digital intensity signal Dx may represent one of the digital intensity signals Da-Dd. The digital intensity signal Dx may carry a digitized value (or number) representing a digitized version of the light intensity signal Lx. The analog-to-digital converter 112y may receive another electronic signal (e.g., Ly) as another of the light intensity signals La-Ld from a light sensor 104a-104d facing in the opposite direction. The analog-to-digital converter 112y may generate a digital intensity signal (e.g., Dy) received by the ambient light control loop 114y and the remote light control loop 116x. The digital intensity signal Dy may represent another one of the digital intensity signals Da-Dd. The digital intensity signal Dy may carry a digital value (or number) representing a digitized version of the light intensity signal Ly.

Each ambient light control loop circuit 114x-114y may receive a display user bias signal (e.g., Ux-Uy) as one of the display user bias signals Ua-Ud. Each ambient light control loop circuit 114x-114y may generate and present a brightness signal (e.g., Bx-By) as one of the brightness signals Ba-Bd. Ambient bias step signals (e.g., ABx-ABy) may be generated by the ambient light control loop circuits 114x-114y and received by the remote light control loop circuits 116x-116y. The ambient bias step signals ABx and ABy may each carry an ambient bias step value (or number).

Each remote light control loop circuit 116x-116y may be in communication with a corresponding ambient light control loop circuit 114x-114y Each remote light control loop circuit 116x-116y may generate an index difference signal (e.g., IDx-IDy). The index difference signals IDx-IDy may be received by the ambient light control loop circuits 114x-114y. The index difference signals IDx-IDy may each convey an index difference value (or number).

The analog-to-digital converters 112x-112y may be operational to convert the analog intensity values received in the light intensity signals Lx and Ly to create the digital intensity signals Dx and Dy. In various embodiments, the conversions performed by the analog-to-digital converters 112x-112y may be linear conversions where the light sensors 104a-104d and/or associated amplifiers have a logarithmic response to the incident light signals LEFT, FRONT, RIGHT and BACK. Each analog-to-digital converter 112x-112y may generate a multi-bit (e.g., 10 bit) digitized value in the digital intensity signals Dx and Dy. Other conversion resolutions may be implemented to meet the design criteria of a particular application.

The ambient light control loop circuits 114x-114y are generally operational to adjust the brightness level value in the brightness signals Bx and By based on the ambient light intensity reported in the digital intensity signals Dx and Dy, the user bias values received in the signals Ux and Uy, and the index difference values received in the index difference signals IDx and IDy. The ambient light control loop circuits 114x-114y may also be operational to generate step values in the ambient bias step signals ABx and ABy based on the digitized intensity values received in the digital intensity signals Dx and Dy and the user bias values received in the signals Ux and Uy.

The remote light control loop circuits 116x-116y are generally operational to generate the index difference values in the index difference signals IDx and IDy based upon the bias step values received in the ambient bias step signals ABx and ABy and the digitized intensity values received in the digital intensity signals Dx and Dy.

The following considers the automatic control of a single electronic display 102a-102d (e.g., 102d). The automatic brightness control of the other electronic displays 102a-102d may be similar using different sets of light sensors 104a-104d as the sources. The digital intensity signal Ld originating from the light sensor 104d may be used to look up a display luminance drive value (e.g., L_{SEL}) in a luminance ratio lookup table within the ambient light control loop of the brightness circuit 110b. The display luminance drive value L_{SEL} may be presented to the electronic display 102d in the brightness signal Bd. An example implementation of a luminance ratio lookup table may be given by the second through fourth columns in Table I as follows:

TABLE I

| BACK (cd/m²) | Dd (10-bit A/D) | Bd (L_{SEL})(cd/m²) | N_{D} |
|---|---|---|---|
| 1.58 | 23 | 52 | 0 |
| 5.04 | 123 | 78 | 1 |
| 16.06 | 223 | 117 | 2 |
| 51.14 | 323 | 176 | 3 |
| 162.90 | 423 | 263 | 4 |
| 518.84 | 523 | 395 | 5 |
| 1652.53 | 623 | 593 | 6 |
| 5263.42 | 723 | 889 | 7 |
| 16764.31 | 823 | 1333 | 8 |
| 53395.37 | 923 | 2000 | 9 |
| 170067.57 | 1023 | 3000 | 10 |

Column 1 (leftmost column) of the Table I generally shows an intensity of the incident light signal BACK sensed by the light sensor 104d. Column 2 may provide the logarithmic digitized intensity values in the digital intensity signal Dd using a 10-bit analog-to-digital converter 112d. Column 2 generally shows that the logarithmic digitized intensity values provide a constant incremental delta between steps with ample analog-to-digital conversion resolution. Column 3 may show the display luminance ratio structure in the brightness signal Bd, where the display luminance ratio between steps may be a constant. Column 4 (rightmost column) may provide a step number (e.g., N_{D}) for each constant incremental delta step of the logarithmic digitized intensity values.

An emitted symbol luminance (e.g., ESL) for the electronic displays 102a-102d is provided by Dr. Silverstein and Hoerner in formula 2 as follows:

ESL=B₀×(DBL)^{C} (2)

The parameter ESL may be the emitted symbol luminance (in cd/m²), B₀ may be a luminance offset constant, DBL may be a display background luminance (in cd/m²) proportional to the ambient light sensor measured value, and C may be a power constant. The power constant C may be a slope of the power function in logarithmic coordinates.

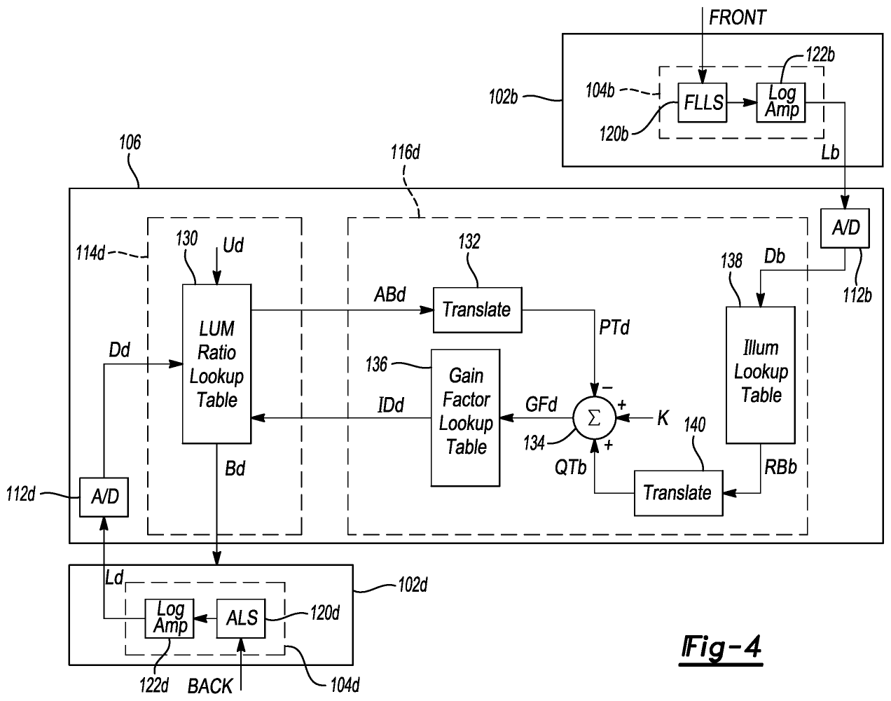

FIG. 4 illustrates a functional flow diagram of an example implementation of the ambient light control loop 114d and the remote light control loop 116d for the back electronic display 102d in accordance with one or more embodiments of the system 90. The ambient light control loops 114a-114c (each represented by an ambient light control loop 114x or 114y in FIG. 3) may be implemented similar to the ambient light control loop 114d. The remote light control loops 116a-116c (each represented by a remote light control loop 116x or 116y in FIG. 3) may be implemented similar to the remote light control loop 116d.

The back electronic display 102d may have the light sensor 104d integrated within. The light sensor 104d may include an ambient light sensor (ALS) function (or circuit) 120d and a logarithmic amplifier (Log Amp) function (or circuit) 122d. The front electronic display 102b may have the light sensor 104b integrated within. The light sensor 104b may include a forward-looking light sensor (FLLS) function 120b and a logarithmic amplifier (Log Amp) function (or circuit) 122b. The control circuit 106 generally comprises analog-to-digital converters 112b and 112d, a luminance ratio lookup table 130, an ambient translation function (or circuit) 132, a summation circuit 134, a gain factor lookup table 136, an illuminance lookup table 138 and a remote translation function (or circuit) 140.

The luminance ratio lookup table 130 may implement a multidimensional table. An example implementation of two dimensions of the luminance ratio lookup table 130 may be the second column through the fourth column of the Table I. The luminance ratio lookup table 130 may present the display luminance drive value L_{SEL} in the brightness signal Bd in response to the digital intensity value received in the digital intensity signal Dd. Additional dimensions of the luminance ratio lookup table 130 may be indexed by the user bias value (e.g., ΔN_{BD}) received in the display user bias signal Ud and by an index difference value (e.g., ΔN) received in an index difference signal (e.g., IDd). Other dimensions of the luminance ratio lookup table 130 may present an adjusted step size (e.g., N_{S}=N_{D}+ΔN_{BD}) in the ambient bias step signal ABd based on the step size N_{D} stored within the table and the user bias value ΔN_{BD} received in the display user bias signal Ud.

The ambient translation function (or circuit or computer program) 132 may be operational to generate an ambient value (e.g., P) in an ambient translation signal (e.g., PTd) by a linear conversion of the adjusted step size N_{D}+ΔN_{BD} received in the ambient bias step signal ABd per formula 3 as follows:

P=(K₃×(N_{D}+ΔN_{BD}))+K₄ (3)

The parameters K₃ and K₄ may be constants.

The summation circuit 134 may be operational to generate a gain factor value (GF) in a gain factor signal (e.g., GFd) based on the ambient value P in the ambient translation signal PTd, a remote value (e.g., Q) in a remote translation signal (e.g., QTb) and a constant value (e.g., K). The gain factor value GF may be the remote value Q plus the constant value K minus the ambient value P. In various embodiments, the constant value K may be 0.2982.

The gain factor lookup table 136 may be operational to generate the index difference value ΔN in the index difference signal IDd based on the gain factor value GF in the gain factor signal GFd. An example implementation of the gain factor lookup table 136 may be provided in Table II as follows:

TABLE II

| GF | ΔN |
|---|---|
| 1 | 0 |
| 1.569295 | 1 |
| 2.462405 | 2 |
| 3.864019 | 3 |
| 6.06344 | 4 |
| 9.514782 | 5 |
| 14.93065 | 6 |
| 23.42925 | 7 |
| 36.7653 | 8 |
| 57.69231 | 9 |
| 90.53108 | 10 |

The illuminance lookup table 138 may be operational to generate a remote bias step value (e.g., N_{H}) in the remote bias step signal RBb based on the digital intensity value received in the digital intensity signal Db. An example implementation of the illuminance lookup table 138 may be provided in Table III as follows:

TABLE III

| Db (10-bit A/D) | N_{H} |
|---|---|
| 23 | 0 |
| 123 | 1 |
| 223 | 2 |
| 323 | 3 |
| 423 | 4 |
| 523 | 5 |
| 623 | 6 |
| 723 | 7 |
| 823 | 8 |
| 923 | 9 |
| 1023 | 10 |

The remote translation function (or circuit or computer program) 140 may be operational to generate the remote translation value Q in the remote translation signal QTb by a linear conversion of the remote bias step value N_{H} in the remote bias step signal RBb per formula 4 as follows:

Q=(K₁×N_{H})+K₂ (4)

The parameters K₁ and K₂ may be constants.

The calculations used to determine the gain factor value GF may utilize the constant luminance ratio concept shown in the Table III (e.g., the illuminance lookup table 138) together with a logarithmic forward-looking light sensor (e.g., the light sensor 104b). In addition to simplifying the power function mathematics to determine the display luminance value L_{SEL}, the same luminance ratio concepts may simplify calculation of the gain factor value GF. To simplify the determination of the gain factor value GF, formula 1 may be rewritten as the summation of three terms as shown in formula 5 and follows:

GF=(1.125×log(FFVI))+(−1.125×log(WSI))+0.2982 (5)

The term −1.125×log(WSI) of the formula 5 may be determined if a constant display luminance ratio construct is utilized as shown in the Table I (e.g., the luminance ratio lookup table 130). Formula 5 may be reformulated to describe the display luminance drive value L_{SEL} as a function of the ambient light sensor determined step number N_{D} and the user bias value ΔN_{BD} per formula 6 as follows:

$${L}_{SEL} = \frac{{L}_{M A X}}{{R}_{D}^{{T}_{D}}} {R}^{( {N}_{D} + Δ {N}_{BD} )} \qquad ( 6 )$$

The parameter R_{D} may be a display luminance ratio between steps, L_{MAX} may be a maximum display luminance, TD may be a total number of steps, R may be a mathematical ratio between successive steps which may be a constant if the light sensors 104a-104d have a logarithmic response, N_{D} may be the step number determined by the digitized ambient light sensor value, and ΔN_{BD} may be the user offset value (or preference) added or subtracted from the N_{D} step number to provide a logarithmic control. Note that the display luminance drive value L_{SEL} term is generally the same as the Silverstein WSI terminology.

Formula 6 may be reformulated to yield formula 7 as follows:

$${log}_{10} ( {L}_{SEL} ) = \frac{{log}_{R} ( \frac{{L}_{MAX}}{{R}_{D}^{{T}_{D}}} ) + ( {N}_{D} + Δ {N}_{BD} )}{{log}_{R} ( 10 )} \qquad ( 7 )$$

Therefore, utilizing formula 7 (with L_{SEL} replacing WSI), the −1.125×log(L_{SEL}) term used in light adaptation gain factor GF calculation of formula 5 may be simplified per formula 7 to the obtain the linear formula 3 since all the terms, except N_{D} and ΔN_{BD}, may be constants. For each step (N_{D}+ΔN_{BD}), a log₁₀(L_{SEL}) lookup table may be compiled per formula 7.

Next, the forward-looking light sensor term 1.125×log(FFVI) in the formula 5 may be extracted from the analog-to-digital converter count value in the digital intensity signal Db. Note that all the terms except N_{H} may constants associated with the logarithmic forward-looking light sensor and the Table III (e.g., the illuminance lookup table 138).

If the gain factor value GF determined by the summation circuit 134 is greater than unity (e.g., 1), the display luminance drive value L_{SEL} determined by the ambient light sensor 104d may be multiplied by the gain factor value GF per the Table II (e.g. the gain factor lookup table 136) to ensure the proper display luminance for light adaptation. If the gain factor value GF is less than unity, the Table II may set the index difference value ΔN to zero and the remote light sensor 104b may be ignored in the light adaptation.

A lookup table that presents the gain factor value GF based on the luminance ratio steps may be constructed starting with formula 8 as follows:

$${L}_{SEL} = \frac{{L}_{MAX}}{{[ \frac{{L}_{MAX}}{{L}_{MIN}} ]}^{( \frac{T - {N}_{S}}{T - 1} )}} \qquad ( 8 )$$

The ambient bias step value Ns may be the (N_{D}+ΔN_{BD}) value from the ambient light sensor calculation per the Table I (e.g., the luminance ratio lookup table 130), and the value T may be a total number of steps (e.g., 10) in the Table I. Per formula 9, a modified luminance value (e.g., L_{GF}) may be calculated by multiplying by the game factor value GF by the display luminance drive value L_{SEL} may be determine by formula 9 as follows:

L_{GF}=GF×L_{SEL} (9)

Manipulation of the formula 8 and the formula 9 may result in formula 10 as follows:

$$( {N}_{G F} - {N}_{S} ) = Δ N = \frac{ln ( GF )}{ln ( {R}_{D} )} \qquad ( 10 )$$

The parameter N_{GF} may be an intended step value N_{D} to get to in the Table I (as a result of the gain factor value GF) from the ambient bias step value N_{S} determined from the ambient light sensor (e.g., the light sensor 104d) and the user bias value (e.g., in the user bias signal Ud). The display luminance ratio value R_{D} between successive steps may defined by formula 11 as follows:

$${R}_{D} = {[ \frac{{L}_{M A X}}{{L}_{M I N}} ]}^{( \frac{1}{T - 1} )} \qquad ( 11 )$$

Formulae 10 and 11 generally show that the current step level of the ambient light sensor does not matter, and that only the index difference value ΔN=(N_{GF}−N_{S}) should be added to the ambient bias step value (N_{D}+ΔN_{BD}) to determine the display luminance drive value L_{SEL} in the brightness signal Bd.

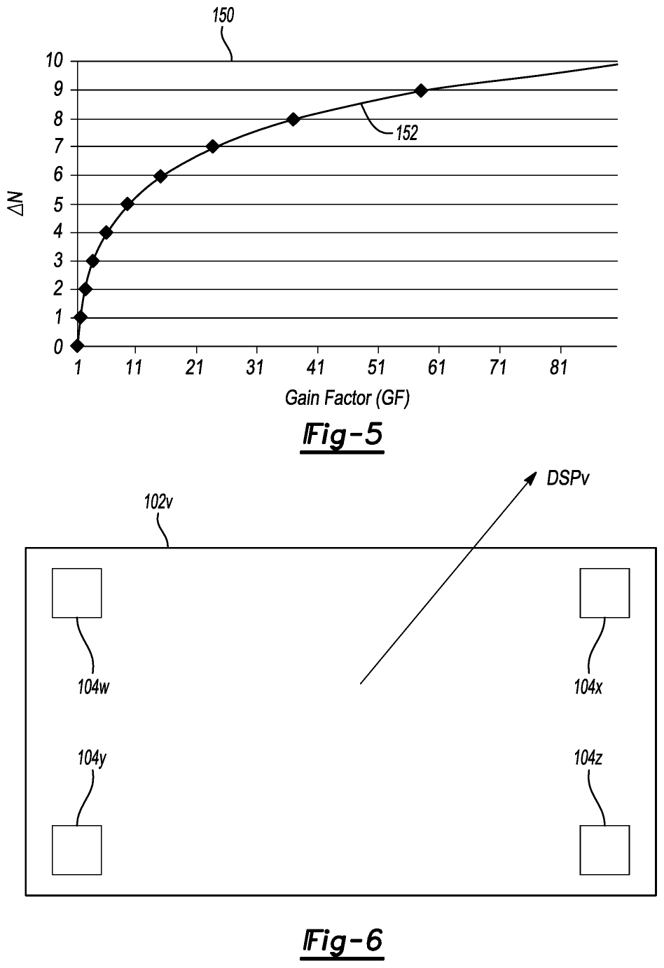

FIG. 5 illustrates a graph 150 of an example relationship between the gain factor value GF and the resulting index difference value ΔN in accordance with one or more embodiments of the system 90. The example relationship (e.g., curve 152) is generally based on L_{MAX}=3,000 cd/m², L_{MIN}=52 cd/m² and T=10 total number of steps. As the gain factor value GF increases linearly, the curve 152 may illustrate a slowing rate of increase for the index difference value ΔN. The relationship may be captured in the gain factor lookup table 136 (Table II).

Returning to FIG. 1, the use of the gain factor lookup table 136 (Table II) may simplify the mathematics and implementation. As an example of the light adaptation gain factor concept, if a scenario occurs where the back light sensor 104d on the back electronic display 102d is shadowed, and the user 92 is looking toward the sunset (e.g., light source 94), the back display luminance may be reduced to 78 cd/m² (N_{D}=1) per the Table I (luminance ratio lookup table 130). However, the user 92 may be squinting due to looking toward the sunset and the front light sensor 104b determines a high luminance level resulting in summation circuit 134 calculating a gain factor value GF=23. Accordingly, per the Table II (the gain factor lookup table 136) the index difference value ΔN for the gain factor value GF=10 is 7 steps. Therefore, the Table I (the luminance ratio lookup table 130) may increase the display luminance drive value L_{SEL} by 7 luminance ratio steps to 1,333 cd/m² (N_{D}=8) and the user 92 may be able to see the information on the back electronic display 102d.

FIG. 6 illustrates a schematic diagram of an example implementation of a multi-light sensor electronic display 102v in accordance with one or more embodiments of the system 90. The electronic display 102v may be representative of any of the electronic displays 102a-102d and the corresponding light sensors 104a-104d. The electronic display 102v may include multiple (e.g., 2 to 4) integrated light sensors 104w-104z. The light sensors 104w-104z may be located proximate each corner of the electronic display 102v. In embodiments with only two integrated light sensors (e.g., 104w-104x), the two light sensors 104w-104x may be located proximate the upper corners of the electronic display 102v.

In operation, the light intensity signals Lw-Lz generated by the light sensors 104w-104z may be peak detected so that the brightest intensity level may be present in the light intensity signal Lv. For example, if the light sensors 104w and 104x are in a shadow and the light sensors 104y and 104z are in normal light, the light intensity signal Lv may present a normal value due mainly to the contributions of the light sensors 104y and 104z. Therefore, a normal brightness value may be presented in the brightness signal By to the electronic display 102v so that the visible light signal DSPv may be based on the normal light rather than the dimmer shadowed light.

The system 90 may provide automatic compensation to each of multiple electronic display luminance for light adaptation mismatch. By using the light adaptation factor in conjunction with a multiple light sensor approach, the electronic display visibilities may be improved under most driving conditions. Additionally, the electronic display luminance's may only be increased to the levels suitable for visibility, and not operated continually at a maximum level, thereby minimizing the electronic display power consumption and improving the thermal performance.

Thus, the foregoing detailed description and the drawings are supportive and descriptive of the disclosure, but the scope of the disclosure is defined solely by the claims. As will be appreciated by those of ordinary skill in the art, various alternative designs and embodiments may exist for practicing the disclosure defined in the appended claims.

1. A system for automatic brightness control of a plurality of displays, comprising:
a first light sensor facing a first direction, and configured to generate a first light intensity signal by logarithmic sensing a first light signal;
a first electronic display of the plurality of displays attachable to a vehicle, facing the first direction such that a first image generated by the first electronic display is visible from outside the vehicle while attached to the vehicle, and having a first brightness responsive to a first brightness signal;
a second light sensor facing a second direction, and configured to generate a second light intensity signal by logarithmic sensing a second light signal, wherein the second direction is substantially opposite the first direction;
a second electronic display of the plurality of displays attachable to the vehicle, facing the second direction such that a second image generated by the second electronic display is visible from outside the vehicle while attached to the vehicle, and having a second brightness responsive to a second brightness signal; and
a control circuit configured to generate the first brightness signal that automatically adjusts the first brightness of the first electronic display using the first light intensity signal in a first ambient light control loop and the second light intensity signal in a first remote light control loop, and generate the second brightness signal that automatically adjusts the second brightness of the second electronic display using the second light intensity signal in a second ambient light control loop and the first light intensity signal in a second remote light control loop, wherein a luminance ratio lookup table is within the first ambient light control loop, the luminance ratio lookup table is configured to present the first brightness signal to the first electronic display in response to the first light intensity signal and a first index difference signal, and the first index difference signal is received from the first remote light control loop.

2. (canceled)

3. The system according to claim 5, wherein the luminance ratio lookup table is further configured to present the ambient bias step signal to the first remote light control loop in response to the first light intensity signal and a display user bias signal.

4. The system according to claim 3, wherein the control circuit further comprises an illuminance lookup table within the first remote light control loop, and the illuminance lookup table is configured to present the remote bias step signal in response to the second light intensity signal.

5. The system according to claim 1, wherein the control circuit comprises a gain factor lookup table within the first remote light control loop, and the gain factor lookup table is configured to present the index difference signal to the first ambient light control loop in response to a remote bias step signal and an ambient bias step signal.

6. The system according to claim 4, wherein the control circuit further comprises a summation circuit configured to generate a gain factor signal in response to the remote bias step signal and the ambient bias step signal, and the gain factor lookup table is responsive to the gain factor signal.

7. The system according to claim 6, wherein the control circuit further comprises an ambient translation circuit within the first remote light control loop between the luminance ratio lookup table and the summation circuit, and the ambient translation circuit is configured to perform a linear translation of an adjusted step size in the ambient bias step signal received from the luminance ratio lookup table.

8. The system according to claim 6, wherein the control circuit further comprises a remote translation circuit within the first remote light control loop between the illuminance lookup table and the summation circuit, and the remote translation circuit is configured to perform a linear translation of a remote bias step value in the remote bias step signal received from the illuminance lookup table.

9. The system according to claim 1, further comprising:
a third light sensor facing a third direction, and configured to generate a third light intensity signal by logarithmic sensing a third light signal;
a third electronic display of the plurality of displays facing the third direction, and having a third brightness responsive to a third brightness signal;
a fourth light sensor facing a fourth direction, and configured to generate a fourth light intensity signal by logarithmic sensing a fourth light signal, wherein the fourth direction is substantially opposite the third direction and substantially orthogonal to the first direction; and
a fourth electronic display of the plurality of displays facing the fourth direction, and having a fourth brightness responsive to a fourth brightness signal,
wherein the control circuit is further configured to generate the third brightness signal that automatically adjusts the third brightness of the third electronic display using the third light intensity signal in a third ambient light control loop and the fourth light intensity signal in a third remote light control loop, and generate the fourth brightness signal that automatically adjusts the fourth brightness of the fourth electronic display using the fourth light intensity signal in a fourth ambient light control loop and the third light intensity signal in a fourth remote light control loop.

10. The system according to claim 1, wherein the first light sensor, the first electronic display, the second light sensor, and the second electronic display are attached to the vehicle.

11. A system for automatic brightness control of a plurality of displays, comprising:
a plurality of first light sensors facing in substantially opposite directions along a first axis, and configured to generate a plurality of first light intensity signals by logarithmic sensing a plurality of first light signals;
a plurality of first electronic displays attachable to a vehicle, facing in substantially opposite directions along the first axis such that a plurality of first images generated by the plurality of first electronic displays are visible from outside the vehicle while attached to the vehicle, and having a plurality of first brightnesses responsive to a plurality of first brightness signals;
a plurality of second light sensor facing in substantially opposite directions along a second axis, and configured to generate a plurality of second light intensity signals by logarithmic sensing of a plurality of second light signals, the second axis being non-parallel to the first axis;
a plurality of second electronic displays attachable to the vehicle, facing in substantially opposite directions along the second axis such that a plurality of second images generated by the plurality of second electronic displays are visible from outside the vehicle while attached to the vehicle, and having a plurality of second brightnesses responsive to a plurality of second brightness signals; and
a control circuit configured to generate the first brightness signals that automatically adjust each of the first brightnesses of the first electronic displays in response to at least two of the first light intensity signals, and generate the second brightness signals that automatically adjust each of the second brightnesses of the second electronic displays in response to at least two of the second light intensity signals, wherein a plurality of luminance ratio lookup tables are within a plurality of ambient light control loops in the control circuit, the plurality of luminance ratio lookup tables are configured to present the plurality of first brightness signals to the plurality of first electronic displays in response to the plurality of first light intensity signals and a plurality of first index difference signals, and the plurality of first index difference signals are received from a plurality of remote light control loops in the control circuit.

12. The system according to claim 11, wherein the ambient light control loops are configured to generate the first brightness signals in response to half of the first light intensity signals and the plurality of first index difference signals received from the remote light control loops, and the remote light control loops are configured to present the first index difference signals in response to another half of the first light intensity signals and a plurality of ambient bias step signals received from the ambient light control loops.

13. The system according to claim 12, wherein each of the ambient light control loops comprises one of the luminance ratio lookup tables configured to present one of the ambient bias step signals to the remote light control loops, and present one of the first brightness signals.

14. The system according to claim 13, wherein each of the remote light control loops comprises an illuminance lookup table configured to present one of a plurality of remote bias step signals in response to one of the first light intensity signals.

15. The system according to claim 14, wherein each of the remote light control loops comprises a gain factor lookup table configured to present one of the index difference signals to the ambient light control loops in response to one of the remote bias step signals and one of the ambient bias step signals.

16. A vehicle with automatic brightness control of a plurality of displays, comprising:
a first light sensor attached to the vehicle, facing a first direction away from the vehicle, and configured to generate a first light intensity signal by logarithmic sensing a first light signal;
a first electronic display of the plurality of displays attached to the vehicle, facing the first direction such that a first image generated by the first electronic display is visible from outside the vehicle, and having a first brightness responsive to a first brightness signal;
a second light sensor attached to the vehicle, facing a second direction away from the vehicle, and configured to generate a second light intensity signal by logarithmic sensing a second light signal, wherein the second direction is substantially opposite the first direction;
a second electronic display of the plurality of displays, attached to the vehicle, facing the second direction such that a second image generated by the second electronic display is visible from outside the vehicle, and having a second brightness responsive to a second brightness signal; and
a control circuit configured to generate the first brightness signal that automatically adjusts the first brightness of the first electronic display using the first light intensity signal in a first ambient light control loop and the second light intensity signal in a first remote light control loop, and generate the second brightness signal that automatically adjusts the second brightness of the second electronic display using the second light intensity signal in a second ambient light control loop and the first light intensity signal in a second remote light control loop, wherein a luminance ratio lookup table is within the first ambient light control loop, the luminance ratio lookup table is configured to present the first brightness signal to the first electronic display in response to the first light intensity signal and a first index difference signal, and the first index difference signal is received from the first remote light control loop.

17. The vehicle according to claim 16, wherein the first light sensor is embedded within the first display.

18. The vehicle according to claim 16, wherein the first light sensor comprises a plurality of light sensors embedded within the first display.

19. The vehicle according to claim 16, wherein the first light sensor and the first electronic display both face ahead of the vehicle, and the second light sensor and the second electronic display both face behind the vehicle.

20. The vehicle according to claim 16, wherein the first light sensor and the first electronic display both face to a left of the vehicle, and the second light sensor and the second electronic display both face to a right of the vehicle.

21. The vehicle according to claim 16, wherein:
the luminance ratio lookup table is further configured to present an ambient bias step signal to the first remote light control loop in response to the first light intensity signal and a display user bias signal;
the control circuit further comprises an illuminance lookup table within the first remote light control loop, and the illuminance lookup table is configured to present a remote bias step signal in response to the second light intensity signal; and
the control circuit further comprises a gain factor lookup table within the first remote light control loop, and the gain factor lookup table is configured to present the index difference signal to the first ambient light control loop in response to the remote bias step signal and the ambient bias step signal.
